(19) United States
(12) Patent Application Publication
(10) Pub. No.: US 2011/0107238 A1
(43) Pub. Date: May 5, 2011

(54) Network-Based Collaborated Telestration on Video, Images or Other Shared Visual Content

(76) Inventors: Dong Liu, Warren, NJ (US); Qiru Zhou, Scotch Plains, NJ (US)

(21) Appl. No.: 12/608,068

(22) Filed: Oct. 29, 2009

(51) Int. Cl. G06F 15/16; G06F 3/048

(52) U.S. Cl. 715/756

(57) ABSTRACT

A telestration system comprises a telestration server configured to communicate with an arbitrary number of telestration clients over a network. The telestration server is further configured to receive telestration input signals from respective ones of the clients and to send telestration output signals to the respective clients, with the telestration output signal sent to a given one of the clients comprising telestration information derived from the telestration input signal received from at least one other one of the clients. Each of the clients with the support of the telestration server can generate a combined telestration overlay for presentation with associated visual content shared between the clients.

### FIELD OF THE INVENTION

The present invention relates generally to communication systems, and more particularly to telestration techniques for use in such systems.

### BACKGROUND OF THE INVENTION

Conventional telestration techniques include various arrangements in which a freehand sketch drawn by a broadcast television operator is superimposed over live video in a broadcast video signal. Such techniques have been widely used in conjunction with sports broadcasting. See, for example, U.S. Pat. No. 3,617,630, issued Nov. 2, 1971 in the name of L. Reiffel and entitled “Superimposed Dynamic Television Display System,” and U.S. Pat. No. 7,075,556, issued Jul. 11, 2006 in the name of K. R. Meier et al. and entitled “Telestrator System.”

Recently, telestration techniques have also been applied in other multimedia applications, such as telemedicine, teleeducation, virtual meetings, media production and interactive network entertainment. See, for example, U.S. Patent Application Publication No. 2007/0167702, published Jul. 19, 2007 in the name of C. J. Hasser et al. and entitled “Medical Robotic System Providing Three-Dimensional Telestration.”

Unfortunately, conventional telestration techniques such as those described in the above-cited references have a number of significant drawbacks. For example, such techniques are generally not suitable for remote multimedia collaboration applications involving multiple arbitrary participants connected via a network such as the Internet. Instead, costly dedicated special-purpose hardware is typically required at each user site, which unduly limits the number of participants while also constraining their respective locations. Such dedicated hardware-based telestration arrangements are also very limited in terms of the particular content formats, geometries, resolutions and other characteristics for which telestration is supported. Moreover, the conventional arrangements generally do not support concurrent telestration on more than one content window without having a separate set of dedicated telestration hardware for each such window.

Accordingly, a need exists for improved telestration techniques which do not suffer from the above-described drawbacks of conventional practice.

### SUMMARY OF THE INVENTION

The present invention in an illustrative embodiment provides a telestration system that facilitates collaboration on shared visual content between an arbitrary number of participants connected via a network such as the Internet, without requiring dedicated special-purpose hardware at each user site.

In accordance with one aspect of the invention, a telestration server is configured to communicate with telestration clients over a network. The telestration server is further configured to receive telestration input signals from respective ones of the clients and to send telestration output signals to the respective clients, with the telestration output signal sent to a given one of the clients comprising telestration information derived from the telestration input signal received from at least one other one of the clients. For example, in an arrangement involving a group of two telestration clients, a first telestration output signal sent by the telestration server to the first client comprises telestration information derived from a telestration input signal received from the second client, and a second telestration output signal sent to the second client by the telestration server comprises telestration information derived from a telestration input signal received from the first client. Groups with other numbers of clients can be configured to operate in a similar manner. Each of the clients in such a group with the support of the telestration server can generate a combined telestration overlay for presentation with associated visual content shared between the clients of that group.

In an illustrative embodiment, the telestration input signal received in the telestration server from a given one of the clients comprises a sequence of telestration commands generated by that client responsive to telestration input entered by a user via an input device associated with the client. The telestration commands may comprise at least one of drawing commands and text commands, with one or more of the telestration commands each comprising fields for at least a client identifier, a shared virtual telestration space identifier, and a telestration type.

The telestration server may be viewed as maintaining a shared video drawing board or other shared virtual telestration space for the plurality of clients, with the shared virtual telestration space combining information derived from the telestration input signals received from each of the clients. The telestration server may store information characterizing the shared virtual telestration space in association with the corresponding shared visual content for subsequent playback.

The telestration server may also be configured to receive from a video server or other source of the shared visual content at least one synchronization signal that is utilized by the telestration server in generating the telestration output signals sent to the respective telestration clients.

The illustrative embodiments provide significant advantages over conventional approaches. For example, one or more of these embodiments support the combination and shared viewing of telestration inputs from arbitrary groups of clients without requiring any modification of an original shared visual content stream, and without any distance limitations or other restrictions on the locations of the clients. The telestration techniques are independent of content format, geometry, resolution and other characteristics, and are highly flexible in terms of the number and type of different video sources or other visual content sources that can be integrated into a single client display. Furthermore, as noted above, the telestration does not require costly dedicated special-purpose hardware, and can instead be implemented, for example, using general-purpose computers and servers.

These and other features and advantages of the present invention will become more apparent from the accompanying drawings and the following detailed description.

### BRIEF DESCRIPTION OF THE DRAWINGS

FIG. 1 is a block diagram of a telestration system in an illustrative embodiment of the invention.

FIG. 2 illustrates an overlay layer and a main video layer of a telestrated video signal in an illustrative embodiment of the invention.

FIG. 3 shows another embodiment of a telestration system in accordance with the invention.

FIGS. 4, 5 and 6 are flow diagrams illustrating the operation of respective drawing client, video renderer and shared virtual drawing board components of the telestration system of FIG. 3.

FIG. 7 is a block diagram of a telestration system illustrating connection of certain system components via a network.

### DETAILED DESCRIPTION OF THE INVENTION

The present invention will be illustrated herein in conjunction with exemplary telestration systems and associated telestration techniques. It should be understood, however, that the invention is not limited to use with the particular types of telestration systems and techniques disclosed. For example, aspects of the present invention can be implemented in a wide variety of other communication system configurations, and in numerous alternative telestration applications.

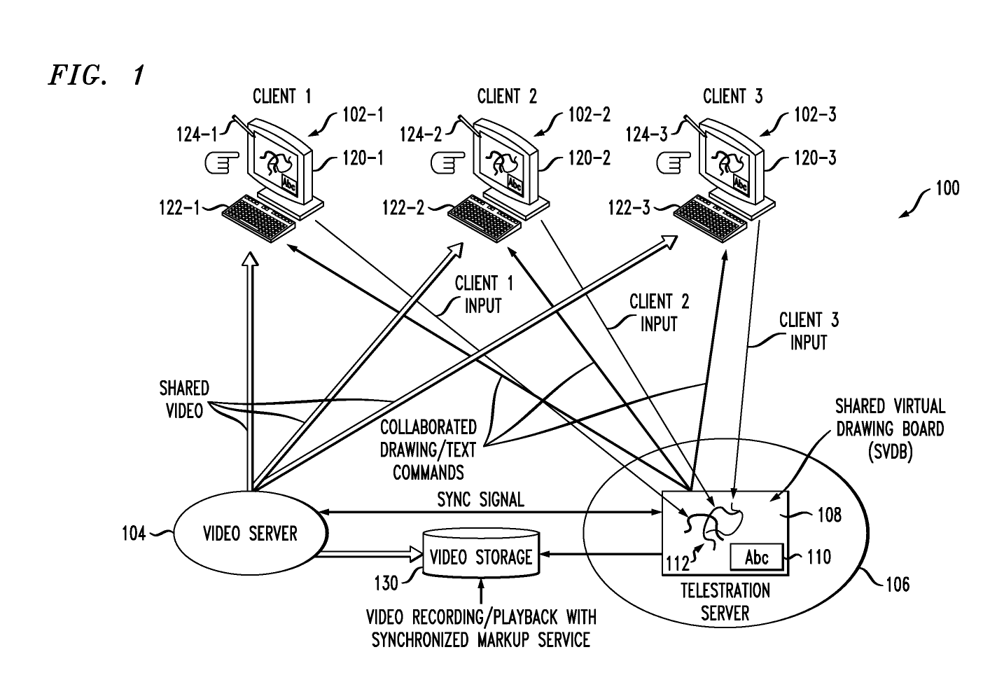

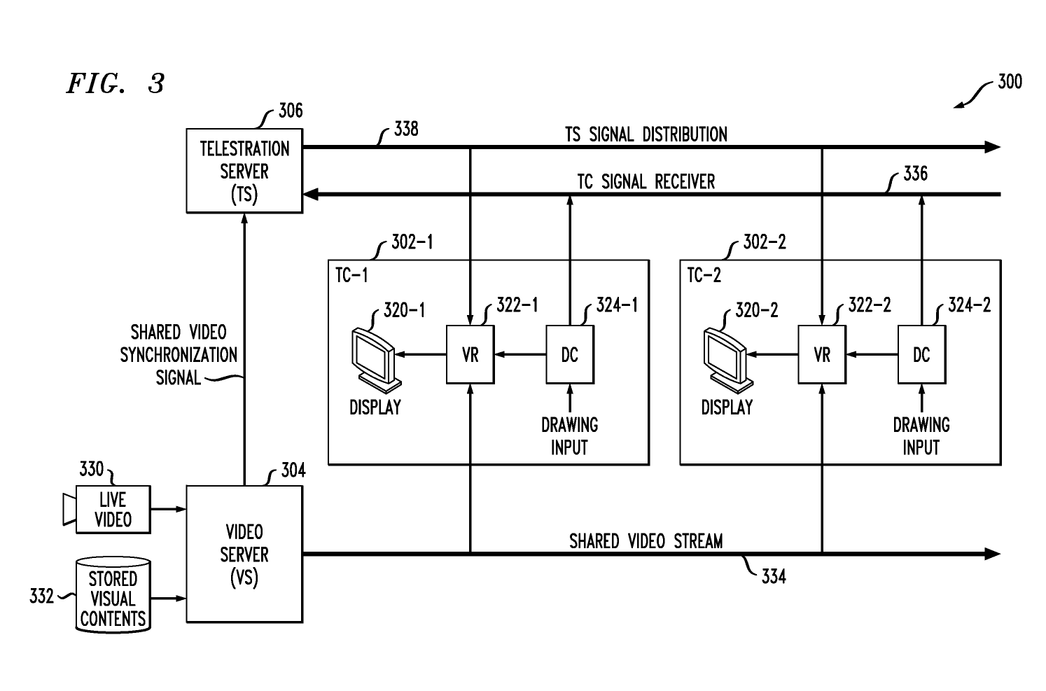

FIG. 1 shows a telestration system 100 comprising a plurality of telestration clients 102-1, 102-2 and 102-3, a video server 104 and a telestration server 106. Although illustratively shown as desktop computers in the figure, the clients 102 may comprise portable or laptop computers, mobile telephones, personal digital assistants (PDAs), wireless email devices, television set-top boxes (STBs) or other types of communication devices, in any combination. It is assumed without limitation that the clients 102, video server 104 and telestration server 106 are configured to communicate over a network, such as the Internet, although such a network is not explicitly shown in FIG. 1. Examples of possible arrangements for interconnecting such devices over a network will be described below in conjunction with the embodiments of FIGS. 3 and 7.

The telestration server 106 supports what is referred to herein as a shared virtual drawing board (SVDB) 108. The SVDB is a collaboration space that is shared by the three clients 102-1, 102-2 and 102-3, also denoted as Client 1, Client 2 and Client 3, respectively, and which supports telestration by each of the clients. That is, each of the clients 102 may provide telestration input and all such inputs are combined into the SVDB. The telestration in this example includes text 110 and freehand drawings 112, although other types of telestration may also or alternatively be supported.

The telestration clients 102 each comprise a corresponding display 120, keyboard 122 and stylus 124 as shown. The telestration input may be provided, for example, as text entered by a user via the keyboard, or by writing directly on the display 120 or an associated drawing input pad with the stylus 124. The display may also or alternatively be configured with touchscreen capability, so as to allow a user to enter telestration input by simply drawing on the display screen with his or her finger as indicated. Other types of telestration input devices may include, for example, an electronic drawing board, a mouse, a remote control device, a Wii controller or other type of video game controller, etc.

The telestration input from each client is sent to the telestration server 106 and combined into the SVDB 108. Although only a single SVDB is shown in this figure, shared by the three clients 102-1, 102-2 and 102-3, the telestration server 106 may be configured to support multiple SVDBs, one for each of a plurality of groups of clients. The telestration server may maintain a given SVDB, by way of example, in the form of a set of telestration input and output signals, with the telestration input signals being received from the clients 102 and the output signals being delivered by the telestration server to the clients 102, as will be described in greater detail below.

The video server 104 sends the same shared video stream to each of the telestration clients 102-1, 102-2 and 102-3. This shared video stream may comprise compressed or uncompressed video with an arbitrary content format, geometry and resolution, and may be sent using any of a number of different transmission techniques, including broadcasting, multicasting or unicasting. The video stream may be, for example, a packetized stream, but any other type of video stream could be used.

It should be noted that the techniques of the illustrative embodiments can be applied to any video format suitable for rendering to a raster display that can be digitally addressed. For example, the disclosed techniques can be adapted for use with an analog live video stream that is converted and rendered to a digital video frame memory buffer. Such an arrangement may be implemented in a system comprising STBs of a cable service that delivers mixed digital and analog TV channels.

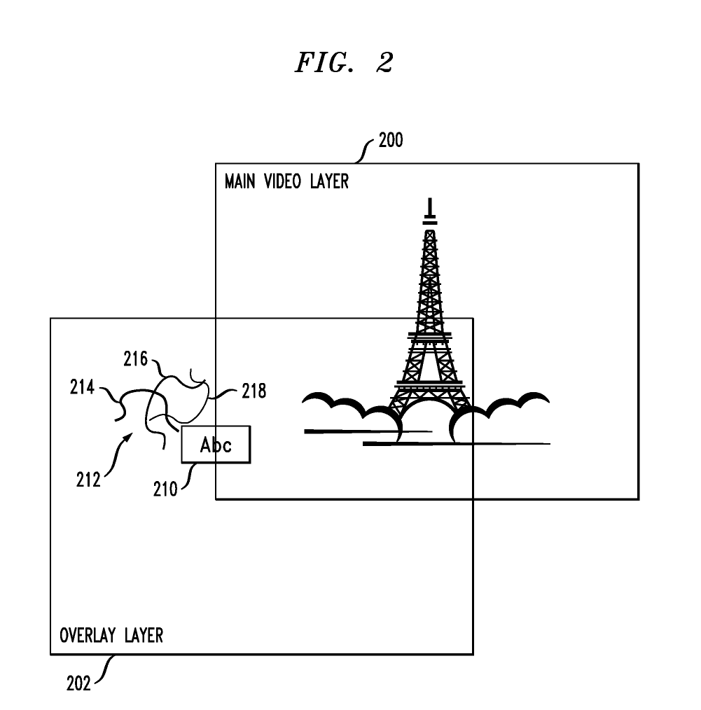

The shared video stream sent by the video server to the clients may be first retrieved by the server from video storage 130, or may be supplied to the server from another video source, such as a video camera or other live video feed. The shared video stream may be viewed as comprising a main video layer 200 as shown in FIG. 2. The users associated with the respective clients 102 enter telestration input over the main video layer of the received shared video stream as presented on display 120 using keyboard 122, stylus 124 or touch input as previously described.

It is to be appreciated that the telestration systems described herein are not limited to use with shared video streams as in the illustrative embodiments but are more generally suitable for use with any of a number of other types of shared visual content, including, by way of example, photos, documents or other images.

As noted previously, the telestration input provided at each of the telestration clients 102 is separately supplied to the telestration server 106 and combined into the SVDB 108. The telestration server then sends collaborated drawing and text commands back to each of the clients 102. The collaborated drawing and text commands are utilized to render a combined telestration overlay layer 202 as shown in FIG. 2 that is presented over the main video layer 200 at each of the clients 102. The overlay layer comprises text 210 and freehand drawings 212, with the drawings including three separate portions 214, 216 and 218 corresponding to telestration input from the respective individual clients 102-1, 102-2 and 102-3.

Each of the telestration clients 102 is able to render the shared video stream from the video server 104 in order to provide the main video layer 200, and is also able to render the collaborated drawing and text commands from the telestration server 106 in order to provide the combined telestration overlay layer containing the combined telestration inputs from all three of the clients 102. It should be noted that the term “overlay” as used herein is intended to be broadly construed, and need not imply a use of separate layers as illustratively shown in FIG. 2. For example, an overlay combining telestration inputs from multiple clients may be generated by appropriate modification of a main video layer. Although separate main video and overlay frame buffers are used in certain embodiments, such arrangements are not a requirement of the invention.

The telestration server 106 may be viewed as gathering and coordinating telestration instruction sequences from the group of three clients 102 sharing the same telestration session in this embodiment. By way of example, the telestration server may generate different sets of collaborated drawing and text commands for each of the clients, in that each client need not separately receive its own telestration information back from the telestration server, since that information is available locally to the client. Thus, Client 1 only needs to receive from the telestration server the collaborated drawing and text commands for the telestration inputs of Clients 2 and 3, Client 2 only needs to receive the collaborated drawing and text commands for Clients 1 and 3, and so on. Each client can thus combine its own telestration input locally with the telestration inputs of the other clients in the group as received from the telestration server in the collaborated drawing and text commands for those clients. Alternatively, the telestration server 106 could be configured to combine the telestration inputs from all of the clients 102 into a single common set of collaborated drawing and text commands that is then sent to each of the clients for use in producing overlay layer 202.

The telestration server 106 keeps track of which clients are in a given telestration session and may also record the corresponding collaborated drawing and text commands of the session in video storage 130, in synchronization with the associated shared video stream from the video server 104. A sync signal may be exchanged between the video server 104 and telestration server 106 for this purpose. Also, this allows the video storage 130 to be used to provide playback of stored video in synchronization with the associated telestration inputs from the various clients sharing the session. Other drawing functions can also be provided, such as per-client erase, roll back and replay.

The telestration system 100 as described in conjunction with FIGS. 1 and 2 advantageously supports the combination and shared viewing of telestration inputs from arbitrary groups of clients without requiring any modification of the original shared video stream. The telestration is therefore independent of the particular format, geometry, resolution and other characteristics of the shared video stream. Furthermore, the telestration does not require costly dedicated special-purpose hardware, and can instead be implemented, for example, using general-purpose computers and servers as shown in FIG. 1.

FIG. 3 shows a telestration system 300 in another embodiment of the invention, illustrating further details of the operations performed within the telestration clients. In this embodiment, the system comprises telestration clients 302-1 and 302-2, video server 304 and telestration server 306, generally configured to operate in a manner similar to the corresponding elements of system 100 as previously described. Two telestration clients are shown, and are more specifically denoted TC-1 and TC-2. The video server and telestration server are also denoted VS and TS, respectively.

Each of the telestration clients 302 comprises a display 320, a video renderer 322 and a drawing client 324. The video renderer and drawing client are also denoted VR and DC, respectively.

The video server 304 receives live video from camera 330 or retrieves stored video contents from video storage 332 and broadcasts, multicasts or unicasts a shared video stream over one or more network connections 334. The shared video stream may be compressed or uncompressed, and may be transmitted over any type of network, including, for example, a data network, a digital television network, an Internet Protocol (IP) television network, a video-on-demand (VOD) network, etc.

The video server also supplies a shared video synchronization signal to the telestration server 306. The synchronization signal is used to coordinate particular telestration inputs with corresponding portions of the shared video stream. This time synchronization supports a variety of advantageous features. For example, it allows recorded telestrated video to be played back with or without the telestration overlay.

The telestration server 306 communicates with the clients 302 over network connections generally denoted 336 and 338. More specifically, the telestration server receives telestration inputs from the clients 302 via network connection 336. These inputs are denoted as TC signals, and the connection 336 is denoted a TC signal receiver line. The telestration server 306 supplies collaborated telestration drawing and text commands to the clients 302 via network connection 338. These outputs are denoted as TS signals, and the connection 338 is denoted a TS signal distribution line. The connections 336 and 338 may comprise Internet connections or other types of signal paths.

The telestration server 306 provides an SVDB for a given group of clients. In this embodiment, the group of clients is assumed to comprise the telestration clients TC-1 and TC-2. Drawing input supplied by a user at each client is processed in the corresponding drawing client 324 and supplied to the telestration server via network connection 336. That same drawing input is applied to one input of the local video renderer 322. Another input of the video renderer 322 receives the collaborated telestration drawing and text commands from the telestration server via network connection 338.

The video renderer 322 combines the collaborated drawing and text commands received from the telestration server 306 with the drawing input from the client in which it is implemented in order to generate an overlay layer. The video renderer renders the overlay layer in combination with a main video layer generated from the shared video stream. It is assumed in this embodiment that the set of collaborated drawing and text commands supplied to each of the telestration clients TC-1 and TC-2 excludes the local drawing and text commands generated within that client, as such local drawing and text commands are supplied directly to the video renderer 322 from the associated drawing client 324. More particularly, the telestration server 306 could supply only the commands received from client TC-1 to client TC-2, and only the commands received from client TC-2 to client TC-1. Thus, in such an arrangement, different sets of drawing and text commands are sent to each telestration client. Alternatively, the same set of drawing and text commands may be sent by the telestration server 306 to each telestration client, with the video renderer 322 within a given such client utilizing only that portion of the received set of commands that are not already available to it locally.

In the FIG. 3 embodiment, the telestration server 306 sends a telestration output signal to TC-1 that comprises telestration information derived from a telestration input signal received from TC-2, and sends a telestration output signal to TC-2 that comprises telestration information derived from a telestration input signal received from TC-1. As indicated above, the same telestration output signal could be sent by the telestration server to both TC-1 and TC-2, with each of these clients utilizing only that portion of the common output signal that is not already available to it locally. The term “derived from” in this context is intended to be broadly construed so as to encompass, for example, an arrangement in which the telestration server receives telestration input signals from one or more of the telestration clients in a given collaboration group and simply retransmits those same signals back to all of the telestration clients within that group. Thus, the telestration output signal(s) could take the form of a combination of the various telestration input signals.

The operation of the system 300 will now be described in greater detail, assuming that a compressed video stream is sent by video server 304 to each of the clients TC-1 and TC-2 over the network connection 334. The received video stream is decompressed and rendered on display 320 by the video renderer 322 in each client. Assume that the user associated with client TC-1 starts to draw a line, circle or other object. The drawing client 324 of TC-1 receives these drawing inputs as an event sequence. It encodes the events into a telestration command sequence that may include, for example, payload fields for TC identifier, SVDB identifier, drawing action command, geometry and color information, and time and sequence code with respect to the shared video stream received from the video server. The SVDB identifier is an example of what is more generally referred to herein as a shared virtual telestration space identifier, and may comprise, for example, a telestration group identifier which identifies a particular group of collaborating telestration clients.

Examples of drawing action commands include the following:

Drawline—drawing command with parameters for start point, end point, pen width, color, etc.

Drawtext—drawing text command with parameters for text box coordinates, font, font size, color, etc.

Drawobject—drawing command for other types of objects such as polygon, circle, 3D shape, etc.

The drawing client 324 sends the encoded drawing inputs as a telestration command sequence to the appropriate SVDB hosted by the telestration server 306. The telestration command sequence can be encoded to reduce the bandwidth requirements of the TC signal connection 336. The telestration server 306 redistributes the telestration command sequence to all of the telestration clients 302 that share the SVDB, in this embodiment TC-1 and TC-2, via the network connection 338. Each of the clients 302 interprets the telestration command sequence and recovers the corresponding drawing object(s) in an overlay video memory frame buffer in generating the telestration overlay layer. At the same time, the clients 302 uncompress the shared video stream to respective main video memory frame buffers. Each client combines frames of the uncompressed shared main video layer with respective frames of the telestration overlay layer in video renderer 322 to render a combined video signal on the display 320. This is repeated over a series of frames such that each user sees on its associated display the same shared video with the combined telestration overlay.

Any of the clients 302 having contribution permission within the group of clients sharing the SVDB provided by telestration server 306 can send a telestration command sequence to the telestration server. The corresponding telestration inputs from the contributing client can be seen substantially instantaneously by all of the other clients of the group. Any of a number of different telestration policies may be applied within a given collaborating group sharing an SVDB.

The telestration clients 302 may also send one or more SVDB control commands as part of a telestration command sequence to the telestration server 306. Examples of these control commands include the following:

NewScreen—clean the SVDB, no parameter.

PauseVideo—Request for all TCs to pause shared live video, no parameter.

Snapshot—Request for all TCs to stop rendering live video, and to fetch a still image, given by a URL as the parameter of this command, from the TS.

ResumeVideo—Request for all TCs to resume the previously paused shared live video rendering.

In the FIG. 3 embodiment, the collaborated telestration is implemented as an asynchronous process. Each video renderer 322 comprises two video frame buffers, including a main shared video frame buffer for storing shared video received from the video server 304, and a telestration overlay frame buffer for storing a telestration overlay that may combine local telestration inputs with those received from other telestration clients via the telestration server 306. The video renderer in this embodiment combines the outputs of the two frame buffers to obtain the overlay telestration effect. There is no requirement to update either one of the two buffers at certain time intervals, nor do these two buffers need to be synchronized. The shared video frame buffer update is content driven. For example, if the shared video is a 720p60 video stream, the main video frame buffer updates 60 times per second. As another example, if an image is used as the shared visual content in place of video, the shared visual content frame buffer will not update until the image changes. Other embodiments may use other types of buffering and rendering arrangements to generate a combined telestration overlay for presentation with associated visual content shared between the clients.

As noted above, at a given one of the telestration clients 302, drawing input from its corresponding drawing client 324 is sent directly to the local video renderer 322 for fast local drawing response. At substantially the same time, this drawing event is encoded and packed as a command and sent to the telestration server 306. The telestration server may then simply redistribute this command to all telestration clients that share the same SVDB, including the given telestration client that sent the command. The foregoing process may occur concurrently for multiple telestration clients, each of which may send commands at substantially the same time. Since each command identifies the sending telestration client and the SVDB, the given telestration client can simply ignore any commands coming back from the telestration server that identify itself as the sending telestration client. This type of asynchronous operation ensures fast local drawing response as well as fast remote drawing updates, although other embodiments may be configured to utilize synchronous operation. The telestration server may optionally record telestration commands with a video synchronization time code in order to facilitate subsequent playback.

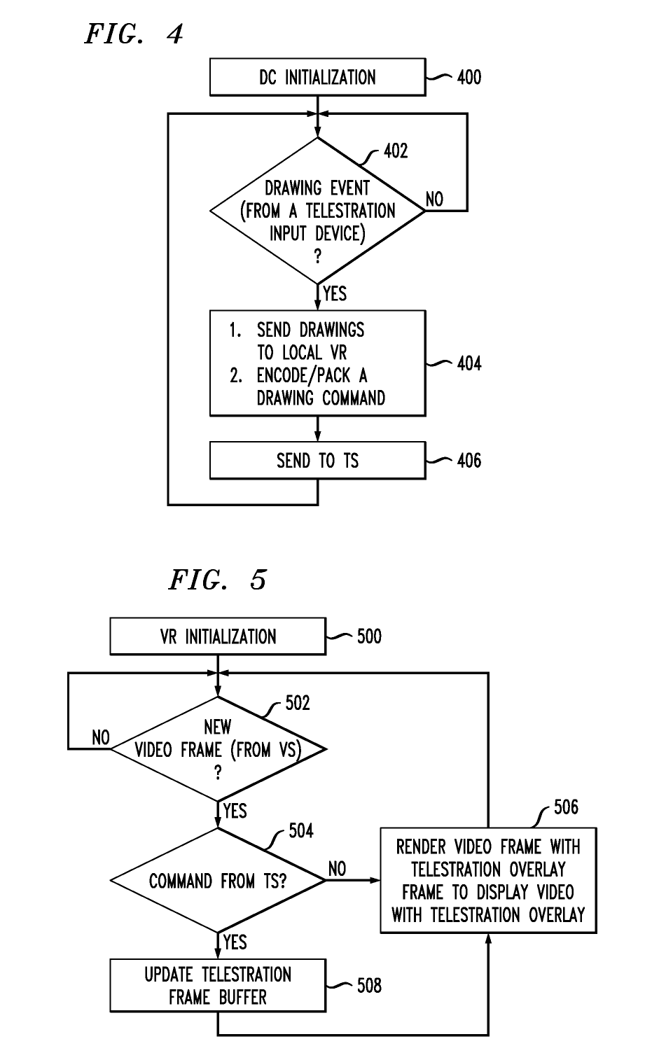

The operation of the drawing client, video renderer and SVDB components of the telestration system 300 will now be described in greater detail with reference to FIGS. 4, 5 and 6, respectively.

Referring initially to FIG. 4, the functionality of the drawing client 324 in TC-1 or TC-2 is shown. In step 400, the drawing client is initialized. Step 402 then determines if a drawing event has occurred, as indicated by receipt of drawing input from a telestration input device such as a keyboard, stylus or touchscreen display. If no such drawing event has occurred, the process remains in step 402 until a drawing event is detected. When a drawing event occurs, the drawing client sends the drawing event to the local video renderer 322, encodes and packs the associated drawing command in step 404, and then sends the encoded and packed command to the telestration server 306 in step 406. The process then returns to step 402 to detect another drawing event. Multiple passes through steps 402, 404 and 406 result in a telestration command sequence being sent from the drawing client 324 to the telestration server 306.

FIG. 5 shows the functionality of the video renderer 322 in TC-1 or TC-2. In step 500, the video renderer is initialized. Step 502 then determines if a new video frame has been received from the video server 304. If no such new video frame has been received, the process remains in step 502 until a new video frame is detected. When a new video frame is detected, the video renderer determines in step 504 if there is at least one telestration command available from the telestration server 306 for the current frame. If there is no such telestration command available, the video renderer simply renders the video frame with the current telestration overlay as determined from the telestration overlay frame buffer as indicated in step 506, and the process returns to step 500. If there is at least one telestration command available in step 504, the video renderer in step 508 updates the telestration overlay frame buffer, and in step 506 displays the current frame of shared video overlayed with the drawing specified by the one or more telestration commands received in step 504. The process then returns to step 500 to reinitialize the video renderer to handle the next frame.

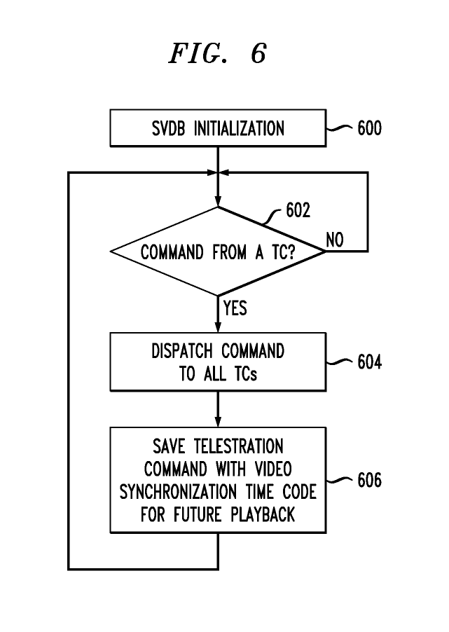

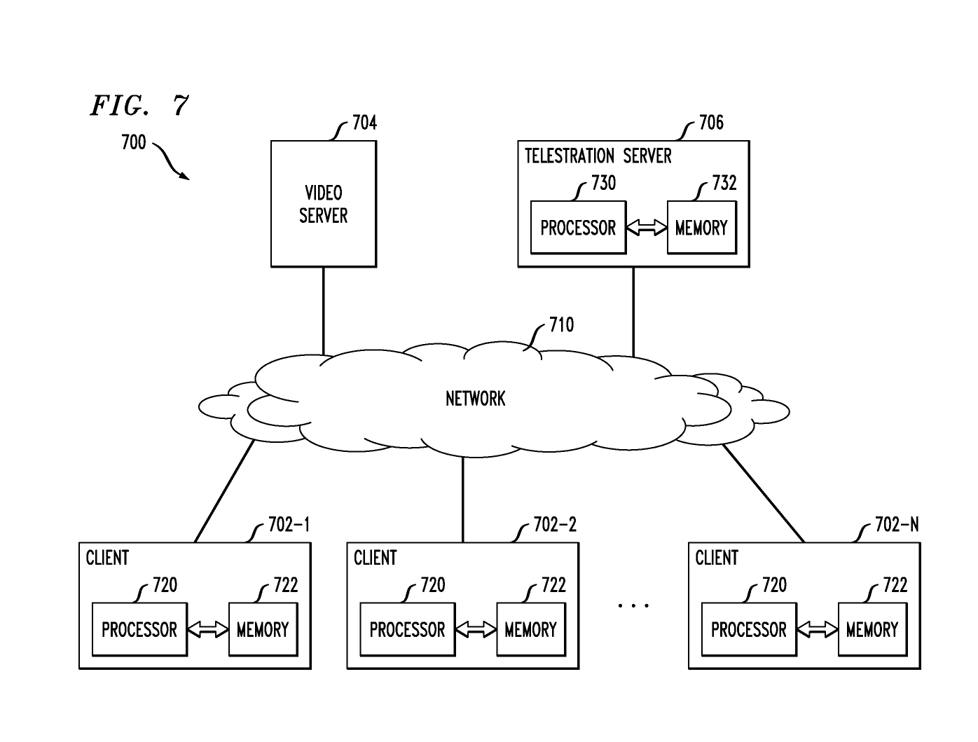

Turning now to FIG. 6, the functionality of the SVDB hosted by the telestration server 306 is shown. In step 600, the SVDB is initialized. Step 602 then determines if a telestration command has been received from a telestration client 302. If no such command has been received, the process remains in step 602 until a telestration command is detected. When a telestration command is detected, the SVDB in step 604 dispatches the command to all of the telestration clients. As noted above, a telestration command received from a given telestration client need not be dispatched back to that client if it has already been made available locally to the video renderer 322 of the given client. In step 606, the SVDB saves the telestration command with a corresponding video synchronization time code for use in future playback. The process then returns to step 602 to await receipt of the next telestration command from a telestration client as indicated.

Like the system 100 of FIG. 1, the telestration system 300 utilizes client-side overlay of combined telestration information from multiple telestration clients. This is achieved without any modification of the source video stream. The same shared video stream can thus be utilized by multiple groups as well as by clients not in any telestration group. The telestration server 306 provides a separate SVDB to each group of collaborating telestration clients. As indicated previously, the telestration is independent of the particular format, geometry, resolution and other characteristics of the shared video stream. A given client can therefore perform telestration on all video sources that it can accept. This provides a high level of flexibility in terms of grouping clients for collaborative telestration. Also, concurrent telestration may be supported on more than one content window without having a separate set of dedicated telestration hardware for each such window.

FIG. 7 shows one possible network-based configuration of a telestration system, such as system 100 or system 300 as previously described. In this embodiment, telestration system 700 comprises an arbitrary number of telestration clients 702-1, 702-2, . . . 702-N, a video server 704, and a telestration server 706, all arranged to communicate over a network 710. Each of the clients 702 comprises a processor 720 coupled to a memory 722. The telestration server 706 similarly comprises a processor 730 coupled to a memory 732.

The memories 722 and 732 may be used to store software programs that are executed by their associated processors 720 and 730 to implement the functionality described herein. For example, software running on processor 730 of telestration server 706 may be used to implement the above-described SVDB, while software running on processors 720 of the telestration clients 702 may be used to implement functionality associated with client components such as video renderer 322 and drawing client 324.

A given one of the memories may be an electronic memory such as random access memory (RAM), read-only memory (ROM) or combinations of these and other types of storage devices. Such a memory is an example of what is more generally referred to herein as a computer program product or still more generally as a computer-readable storage medium that has executable program code embodied therein. Other examples of computer-readable storage media may include disks or other types of magnetic or optical media, in any combination.

The system 700 may include additional components configured in a conventional manner. For example, each of the clients 702 and the servers 704, 706 will generally include network interface circuitry for interfacing with the network 710.

A number of examples of applications of a telestration system such as the telestration system 100, 300 or 700 will now be described.

### Example Application 1

A sports telestration service is provided to a group of friends that are fans of a common sport and are remotely located from one another. The service allows such a group of friends to reserve a visual chat room with real-time audio conferencing and a shared telestration drawing board overlay on each of their television displays. With reference to the telestration system 300 of FIG. 3, the video renderer 322 and drawing client 324 may be implemented in the STB of each user. During a game, each of the friends can use a drawing device connected to his or her STB to provide telestration input on shared broadcast video of the game. One friend can mark sections of the video to emphasize a point and others may talk back via real-time audio or may draw back by entering their own telestration inputs.

### Example Application 2

A surgical telestration service is provided to a hospital. A surgeon at the hospital is conducting brain surgery on a patient and would like to consult during the operation with another surgeon in a remote location. The hospital uses the service to send live video of the operation to the remote location, and the surgeon at the remote location can telestrate his opinion or other input on the live video that he shares with the surgeon in the operating room.

It is to be appreciated that these examples are presented by way of illustration only, and the telestration systems disclosed herein can be used in numerous other applications, such as interactive entertainment, interactive IPTV, advanced teleconferencing, military and security applications, etc.

As mentioned above, the illustrative embodiments allow an arbitrary number of remote participants to telestrate on video, images, and other shared visual content, without any distance restrictions on the locations of the participants. The telestration techniques are independent of content format, geometry, resolution and other characteristics, and are highly flexible in terms of the number and type of different video sources that can be integrated into a single client display. Moreover, there is no need to alter the original shared content in any way when implementing network collaborated telestration using the disclosed techniques. A given telestration system configured as described herein can be implemented at low cost using general-purpose client and server devices.

As indicated previously, embodiments of the present invention may be implemented at least in part in the form of one or more software programs that are stored in a memory or other computer-readable medium of a telestration client or a telestration server. System components such as the SVDB, VR and DC may be implemented at least in part using software programs. Of course, numerous alternative arrangements of hardware, software or firmware in any combination may be utilized in implementing these and other system elements in accordance with the invention. For example, embodiments of the present invention may be implemented in one or more application-specific integrated circuits or other types of integrated circuit devices, in any combination.

It should again be emphasized that the embodiments described above are for purposes of illustration only, and should not be interpreted as limiting in any way. Other embodiments may use different types of communication system components, client and server device configurations, and network connections, depending on the needs of the particular telestration application. Alternative embodiments may therefore utilize the techniques described herein in other contexts in which it is desirable to implement effective telestration for arbitrary numbers of clients over a network.

It should also be noted that the particular assumptions made in the context of describing the illustrative embodiments should not be construed as requirements of the invention. The invention can be implemented in other embodiments in which these particular assumptions do not apply.

These and numerous other alternative embodiments within the scope of the appended claims will be readily apparent to those skilled in the art.

What is claimed is:

1. An apparatus comprising:
a telestration server configured to communicate with a plurality of telestration clients over a network;
the telestration server being further configured to receive telestration input signals from respective ones of the clients and to send telestration output signals to the respective clients, with the telestration output signal sent to a given one of the clients comprising telestration information derived from the telestration input signal received from at least one other one of the clients, such that each of the clients with support of the telestration server can generate a combined telestration overlay for presentation with associated visual content shared between the clients.

2. The apparatus of claim 1 wherein the shared visual content comprises at least one of shared video, image or document content.

3. The apparatus of claim 1 wherein a first one of the telestration output signals sent to a first one of the clients comprises telestration information derived from the telestration input signal received from a second one of the clients and a second one of the telestration output signals sent to the second client comprises telestration information derived from the telestration input signal received from the first client.

4. The apparatus of claim 1 wherein the telestration input signal received in the telestration server from the given one of the clients comprises a sequence of telestration commands generated by that client responsive to telestration input entered by a user via an input device associated with said client.

5. The apparatus of claim 4 wherein the telestration commands comprise at least one of drawing commands and text commands.

6. The apparatus of claim 4 wherein one or more of the telestration commands each comprise fields for at least a client identifier, a shared virtual telestration space identifier, and a telestration type.

7. The apparatus of claim 1 wherein the telestration server is further configured to maintain a shared virtual telestration space for the plurality of clients with the shared virtual telestration space combining information derived from the telestration input signals received from each of the clients.

8. The apparatus of claim 7 wherein the telestration server is further configured to store information characterizing the shared virtual telestration space in association with the shared visual content for subsequent playback.

9. The apparatus of claim 1 wherein the telestration server is further configured to receive from a source of the shared visual content at least one synchronization signal that is utilized by the telestration server in generating the telestration output signals sent to the respective clients.

10. The apparatus of claim 1 wherein a first one of the telestration output signals sent to a first one of the clients comprises telestration information derived from the telestration input signal received from at least a second one of the clients but no telestration information derived from the telestration input signal received from the first client.

11. The apparatus of claim 1 wherein a first one of the telestration output signals sent to a first one of the clients comprises telestration information derived from the telestration input signal received from at least a second one of the clients in addition to telestration information derived from the telestration input signal received from the first client.

12. A method comprising:
receiving telestration input signals in a telestration server from respective ones of a plurality of telestration clients;
processing the received telestration input signals in the telestration server to generate telestration output signals for delivery to the respective clients; and
sending the telestration output signals from the telestration server to the respective clients;
wherein the telestration output signal sent to a given one of the clients comprises telestration information derived from the telestration input signal received from at least one other one of the clients, such that each of the clients with support of the telestration server can generate a combined telestration overlay for presentation with associated visual content shared between the clients.

13. The method of claim 12 further comprising the step of maintaining in the telestration server a shared virtual telestration space for the plurality of clients with the shared virtual telestration space combining information derived from the telestration input signals received from each of the clients.

14. A computer-readable storage medium having embodied therein executable program code that when executed by a processor of the telestration server causes the telestration server to perform the steps of the method of claim 12.

15. An apparatus comprising:
a first telestration client configured to communicate with a telestration server over a network;
the first client being configured to send a telestration input signal to the telestration server, and to receive from the telestration server a telestration output signal comprising telestration information derived from at least one other telestration input signal received in the telestration server from at least one other telestration client;
wherein the first client utilizes the telestration output signal received from the telestration server to generate a combined telestration overlay for presentation with associated visual content shared between the first client and said at least one additional client.

16. The apparatus of claim 15 wherein the first client further comprises:
a telestration input component generating the telestration input signal responsive to telestration input entered by a user via an input device associated with said client; and
a rendering component for rendering the combined telestration overlay and the associated shared visual content.

17. The apparatus of claim 16 wherein the rendering component further comprises a telestration overlay frame buffer from which the combined telestration overlay is rendered and a main frame buffer from which the shared visual content is rendered.

18. The apparatus of claim 16 wherein the telestration input signal sent by the first client to the telestration server comprises a sequence of telestration commands with at least one of said commands comprising fields for at least a client identifier, a shared virtual telestration space identifier, and a telestration type.

19. A method comprising:
sending a telestration input signal from a first telestration client to a telestration server;
receiving from the telestration server a telestration output signal comprising telestration information derived from at least one other telestration input signal received in the telestration server from at least one other telestration client; and
utilizing the telestration output signal received from the telestration server to generate a combined telestration overlay for presentation with associated visual content shared between the first client and said at least one additional client.

20. The method of claim 19 further comprising the steps of:
generating the telestration input signal responsive to telestration input entered by a user via an input device associated with the first telestration client; and
rendering the combined telestration overlay and the associated shared visual content.

21. The method of claim 20 wherein the rendering step further comprises the steps of:
rendering the shared visual content from a first buffer of the first client; and
rendering the combined telestration overlay from a second buffer of the first client, the second buffer being separate from the first buffer.

22. The method of claim 19 wherein the telestration input signal sent by the first client comprises a sequence of telestration commands with at least one of said commands comprising fields for at least a client identifier, a shared virtual telestration space identifier, and a telestration type.

23. A computer-readable storage medium having embodied therein executable program code that when executed by a processor of the first telestration client causes the first client to perform the steps of the method of claim 19.

24. A telestration system comprising:
a telestration server; and
a plurality of telestration clients;
wherein the telestration server is configured to communicate with the plurality of clients over a network;
the telestration server being further configured to receive telestration input signals from respective ones of the clients and to send telestration output signals to the respective clients, with the telestration output signal sent to a given one of the clients comprising telestration information derived from the telestration input signal received from at least one other one of the clients, such that each of the clients with support of the telestration server can generate a combined telestration overlay for presentation with associated visual content shared between the clients.

25. The system of claim 24 further comprising a content server configured to communicate with the plurality of clients over the network so as to supply said clients with the shared visual content.
